(19) United States
(12) Patent Application Publication
(10) Pub. No.: US 2020/0309523 A1
(43) Pub. Date: Oct. 1, 2020

(54) GIMBAL CONTROL METHOD, MOVABLE OBJECT, STORAGE DEVICE, GIMBAL CONTROL SYSTEM AND GIMBAL

(71) Applicant: SZ DJI OSMO TECHNOLOGY CO., LTD., Shenzhen (CN)

(72) Inventors: Shuai Liu, Shenzhen (CN); Yingzhi Wang, Shenzhen (CN); Wenjun Wang, Shenzhen (CN)

(21) Appl. No.: 16/902,744

(22) Filed: Jun. 16, 2020

Related U.S. Application Data
(63) Continuation of application No. PCT/CN2017/116961, filed on Dec. 18, 2017.

(51) Int. Cl. G01C 17/38; B64C 39/02; B64D 47/08; B64D 41/00

(52) U.S. Cl. CPC G01C 17/38; B64C 39/024; B64C 2201/127; B64D 41/00; B64D 47/08

(57) ABSTRACT

A gimbal control method includes determining whether a movable object enters a compass calibration mode and, when the movable object enters the compass calibration mode, controlling a gimbal movement of a gimbal carried by the movable object so that the gimbal remains relatively stationary relative to the movable object.

### CROSS-REFERENCE TO RELATED APPLICATION

This application is a continuation of International Application No. PCT/CN2017/116961, filed Dec. 18, 2017, the entire content of which is incorporated herein by reference.

### TECHNICAL FIELD

The present disclosure relates to a gimbal control method, a movable object using the gimbal control method, a gimbal control system and a gimbal, and a storage device storing program instructions related to the gimbal control method.

### BACKGROUND

Gimbal is generally mounted at a movable object such as an unmanned aerial vehicle (UAV), and is used to carry a load such as a camera or a video camera. The attitude control of the load is achieved through the attitude control of the gimbal. The movable object, such as UAV, often includes a compass, which is used to inform the movable object of the true north in order to correctly identify the azimuth during the movement of the movable object. However, the compass is particularly susceptible to interference, and it is often needed to calibrate the compass during use. For example, a typical process for calibrating a compass of a UAV is that the user carries the UAV and makes a horizontal circle and then a vertical circle. If the user's operations are not standardized, such as turning too fast, the gimbal flutters and will easily hit the mechanical limit mechanism, which will cause the gimbal motor to output large torque for a long time, resulting in damages to the gimbal or motor. On the other hand, activating the logic of avoiding the limit mechanism will make the attitude of the gimbal after the compass calibration inconsistent with the attitude before the compass calibration, therefore the user experience is not good.

### SUMMARY

In accordance with the disclosure, there is provided a gimbal control method that includes determining whether a movable object enters a compass calibration mode and, when the movable object enters the compass calibration mode, controlling a gimbal movement of a gimbal carried by the movable object so that the gimbal remains relatively stationary relative to the movable object.

Also in accordance with the disclosure, there is provided a storage device storing instructions that, when executed by a processor, cause the processor to perform the above gimbal control method.

Also in accordance with the disclosure, there is provided a movable object including a gimbal, a compass, and a control device that is configured to determine whether the movable object enters a compass calibration mode and, when the movable object enters the compass calibration mode, control a gimbal movement of the gimbal so that the gimbal remains relatively stationary relative to the movable object.

Also in accordance with the disclosure, there is provided a gimbal control system including a gimbal configured to be disposed at a movable object, a remote control device configured to send an instruction signal for controlling the gimbal, a storage device storing program instructions, and a control device configured to receive the instruction signal sent by the remote control device and execute the program instructions stored at the storage device to determine whether the movable object enters a compass calibration mode and, when the movable object enters the compass calibration mode, control a gimbal movement of the gimbal so that the gimbal remains relatively stationary relative to the movable object.

### BRIEF DESCRIPTION OF THE DRAWINGS

FIG. 1 is a flowchart of a gimbal control method according to an embodiment of the disclosure.

FIG. 2 is a flowchart of a gimbal control method according to an example embodiment of the disclosure.

FIG. 3 is a flowchart of a gimbal control method according to another example embodiment of the disclosure.

FIG. 4 is a flowchart of a gimbal control method according to another example embodiment of the disclosure.

FIG. 5 is a system block diagram of an unmanned aerial vehicle (UAV) according to an embodiment of the disclosure.

FIG. 6 is a system block diagram of a UAV according to another embodiment of the disclosure;

FIG. 7 is a system block diagram of a gimbal control system according to an embodiment of the disclosure.

### DETAILED DESCRIPTION OF THE EMBODIMENTS

The technical solutions in the example embodiments of the present disclosure will be described in more detail with reference to the accompanying drawings. The described embodiments are intended to explain the general idea of the present disclosure, rather than limiting the present disclosure. The same or similar reference numerals refer to the same or similar parts or components. For clarity, the drawings are not necessarily drawn to scale, and some well-known components and structures may be omitted from the drawings.

Unless otherwise defined, the technical or scientific terms used in the present disclosure have the ordinary meanings understood by those having ordinary skills in the art to which the present disclosure belongs. The terms “first,” “second,” and the like used in this disclosure do not indicate any order, quantity, or importance, but are only used to distinguish different components. Words such as “including” or “comprising” mean that the element or item appearing before the word includes the element or item appearing after the word and the equivalent thereof without excluding other elements or items. Words such as “connected” or “connecting” are not limited to physical or mechanical connections, but may include electrical connections, whether direct or indirect. “Up,” “down,” “left,” “right,” “top,” or “bottom” are only used to indicate the relative position relationship. When the absolute position of the described object changes, the relative position relationship may also be changed accordingly. When an element such as a layer, film, region, or substrate is referred to as being “on” or “under” another element, the element can be “directly on” or “under” the other element, or there may be intermediate elements.

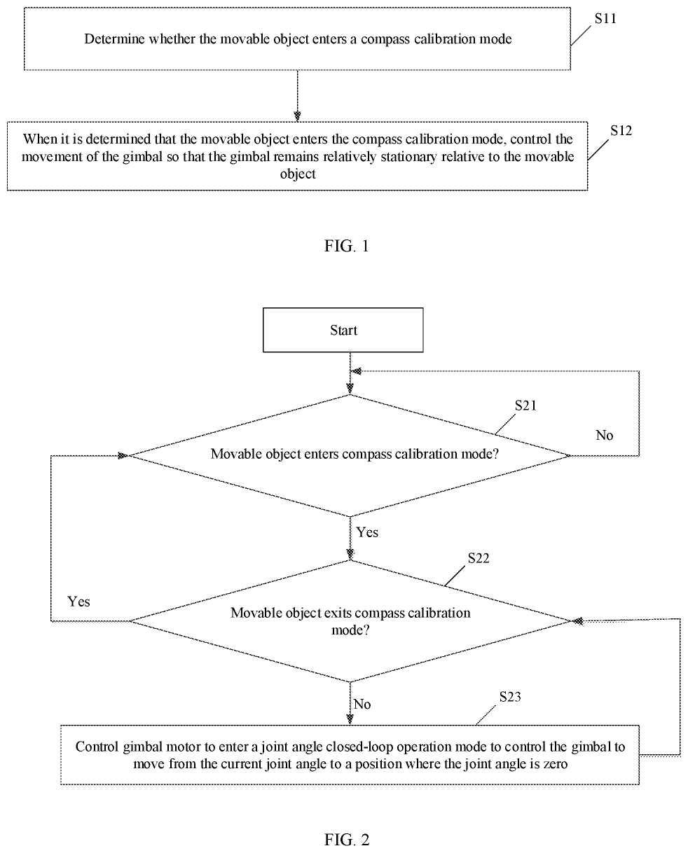

FIG. 1 is a flowchart of a gimbal control method according to an embodiment of the present disclosure. The gimbal control method is applied to a movable object including a gimbal. In the embodiments of the present disclosure, an unmanned aerial vehicle (UAV) is used as an example to describe the gimbal control method of the present disclosure. Those having ordinary skills in the art should understand that the movable object is not limited to UAVs. For example, the movable object can also be an unmanned ship, an unmanned vehicle, a manned aerial vehicle, or any movable object equipped with a stabilizing gimbal and a compass, which is not limited here.

FIG. 1 shows the gimbal control method. At S11, it is determined whether the movable object enters a compass calibration mode.

For example, to determine whether the movable object enters the compass calibration mode, an instruction signal of entering the compass calibration can be sent to the UAV's flight controller via a remote control. After receiving the instruction signal, the UAV's flight controller can determine that the UAV enters the compass calibration mode. Alternatively, a control button can be set on the gimbal or the UAV, and when the user presses the control button, the flight controller is notified that the UAV enters the compass calibration mode.

At S12, when it is determined that the movable object enters the compass calibration mode, the movement of the gimbal is controlled so that the gimbal remains relatively stationary relative to the movable object.

For example, after the flight controller receives an instruction signal of entering the compass calibration mode from the remote control, the flight controller controls the movement of the gimbal through the gimbal motor, so that the gimbal remains relatively stationary relative to the movable object.

Those skilled in the art can also conceive and adopt other feasible manners to keep the gimbal relatively stationary relative to the movable object when the movable object enters the compass calibration mode. These methods also fall within the scope of this disclosure.

According to the gimbal control method of the embodiments, when it is determined that the movable object enters the compass calibration mode, the movement of the gimbal is controlled so that the gimbal remains relatively stationary relative to the movable object. As a result, the gimbal can be prevented from random movement during compass calibration that can cause the gimbal to hit the mechanical limit mechanism and damage the gimbal or motor.

FIG. 2 is a flowchart of a gimbal control method according to another embodiment of the present disclosure. As shown in FIG. 2, at S21, it is determined whether a movable object enters a compass calibration mode.

For example, to determine whether the movable object enters the compass calibration mode, an instruction signal of entering the compass calibration mode can be sent to the UAV's flight controller via a remote control. After receiving the instruction signal, the UAV's flight controller can determine that the UAV enters the compass calibration mode, and then the control process proceeds to S22. If the UAV's flight controller does not receive an instruction signal of entering the compass calibration mode, it can be determined that the UAV has not entered the compass calibration mode. The flight controller may continuously monitor whether the remote control sends an instruction signal of entering the compass calibration mode until the instruction signal is received.

When it is determined at S21 that the movable object enters the compass calibration mode, at S22, it is determined whether the movable object exits the compass calibration mode.

For example, to determine whether the movable object exits the compass calibration mode, an instruction signal of exiting the compass calibration mode can be sent to the UAV's flight controller via the remote control. After receiving the instruction signal, the UAV's flight controller can determine that the UAV exits the compass calibration mode. The compass calibration mode can be exited after completing the compass calibration, or during the calibration. At this time, the control process returns to S21, and the flight controller continuously monitors whether the remote control sends an instruction signal of entering the compass calibration mode. Conversely, if the UAV's flight controller does not receive an instruction signal of exiting the compass calibration mode at S22, it can be determined that the UAV has not exited the compass calibration mode, and the control process proceeds to S23.

At S23, when it is determined that the movable object enters the compass calibration mode and does not exit, the gimbal motor is controlled to enter a joint angle closed-loop operation mode. In the joint angle closed-loop operation mode, the gimbal is controlled to move from the current joint angle to a position where the joint angle is zero, also referred to as a “zero-angle position.” Specifically, according to the current joint angle of the gimbal, T-shaped velocity planning can be performed, and a trapezoidal movement curve is automatically planned, so that the gimbal can smoothly move to a zero-angle position. When the gimbal has multiple motors, each gimbal motor is used as an individual control object, and each motor is individually controlled with a position closed-loop operation.

During the compass calibration, this control process can be performed continuously and dynamically to lock the gimbal to a zero-angle position. That is, whenever the joint angle deviates from the zero-angle position, the gimbal motor is controlled to return the gimbal to the zero-angle position. For example, when the position sensor detects that the joint angle is negative, a forward torque is provided to the gimbal motor to make the motor rotate forth. Conversely, when a positive joint angle is detected, a backward torque is provided to the gimbal motor to make the motor rotate back.

Thereafter, the control process may return to S22. The flight controller may continuously monitor whether the remote control sends an instruction signal of exiting the compass calibration mode. If the flight controller does not receive the instruction signal of exiting the compass calibration, it will continue controlling the gimbal motor to execute the joint angle closed-loop operation mode to lock the gimbal to the zero-angle position.

According to the gimbal control method of the embodiments, when it is determined that the movable object enters the compass calibration mode, the gimbal motor is controlled to enter a joint angle closed-loop operation mode. In the joint angle closed-loop operation mode, the gimbal is controlled to move from the current joint angle to a zero-angle position, and is locked to the zero-angle position. In this way, during the compass calibration, the gimbal remains relatively stationary relative to the movable object. As a result, the gimbal can be prevented from random movement during compass calibration that can cause the gimbal to hit the mechanical limit mechanism and damage the gimbal or motor. In addition, the control method of the embodiments can be automatically executed by the flight controller with a written program, which improves the accuracy of the control and the convenience of the user.

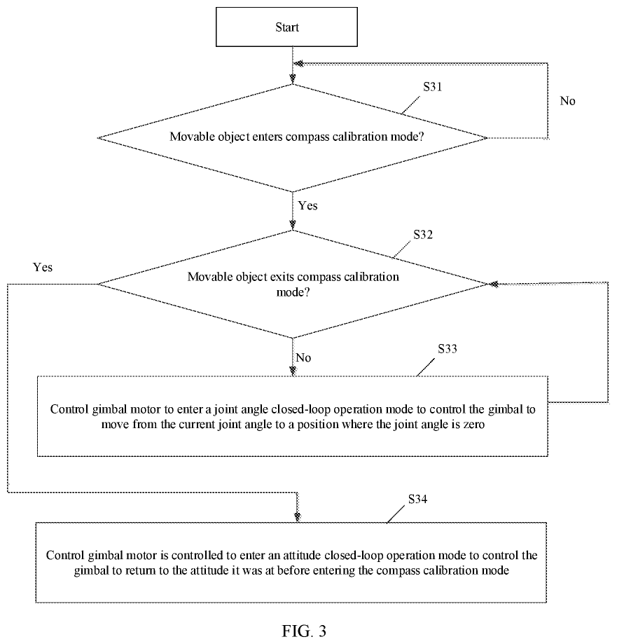

FIG. 3 is a flowchart of a gimbal control method according to another embodiment of the present disclosure. As shown in FIG. 3, at S31, it is determined whether a movable object enters a compass calibration mode.

For example, to determine whether the movable object enters the compass calibration mode, an instruction signal of entering the compass calibration mode can be sent to the UAV's flight controller via a remote control. After receiving the instruction signal, the UAV's flight controller can determine that the UAV enters the compass calibration mode, and then the control process proceeds to S32. Conversely, if the UAV's flight controller does not receive an instruction signal of entering the compass calibration mode, it can be determined that the UAV has not entered the compass calibration mode. The flight controller may continuously monitor whether the remote control sends an instruction signal of entering the compass calibration mode until the instruction signal is received.

If it is determined at S31 that the movable object enters the compass calibration mode, at S32, it is determined whether the movable object exits the compass calibration mode.

For example, to determine whether the movable object exits the compass calibration mode, an instruction signal of exiting the compass calibration mode can be sent to the UAV's flight controller via the remote control. After receiving the instruction signal, the UAV's flight controller can determine that the UAV exits the compass calibration mode. The compass calibration mode can be exited after completing the compass calibration, or during the calibration. If the UAV's flight controller does not receive an instruction signal of exiting the compass calibration mode at S32, it can be determined that the UAV has not exited the compass calibration mode, and the control process proceeds to S33.

At S33, when it is determined that the movable object enters the compass calibration mode and does not exit, the gimbal motor is controlled to enter a joint angle closed-loop operation mode. The joint angle closed-loop operation mode is an automatic control process in which the joint angle of the gimbal is used as a control object, and the output amount of the joint angle of the gimbal is controlled to zero using a closed-loop control method. Specifically, according to the current joint angle of the gimbal, T-shaped velocity planning can be performed, and a trapezoidal movement curve is automatically planned, so that the gimbal can smoothly move to the zero-angle position. When the gimbal has multiple axes, the joint angle of each axis is controlled with the joint angle closed-loop operation.

During the compass calibration, this control process can be performed continuously and dynamically to lock the gimbal to a zero-angle position. That is, whenever the joint angle deviates from the zero-angle position, the gimbal motor is controlled to return the gimbal to the zero-angle position. For example, when the position sensor detects that the joint angle is negative, a forward torque is provided to the gimbal motor to make the motor rotate forth. Conversely, when a positive joint angle is detected, a backward torque is provided to the gimbal motor to make the motor rotate back.

Thereafter, the control process may return to S32. The flight controller may continuously monitor whether the remote control sends an instruction signal of exiting the compass calibration mode. If the flight controller does not receive the instruction signal of exiting the compass calibration, it will continue controlling the gimbal motor to execute the joint angle closed-loop operation mode to lock the gimbal to the zero-angle position.

On the other hand, if the UAV's flight controller receives an instruction signal of exiting the compass calibration at S32, it can be determined that the UAV exits the compass calibration mode, and the control process proceeds to S34. At S34, the flight controller controls the gimbal to enter the attitude closed-loop operation mode. In the attitude closed-loop operation mode, the flight controller aims to control the attitude of the gimbal. According to the real-time measurement signal sent from measurement elements such as position sensors or attitude sensors, the flight controller performs attitude closed-loop control over the gimbal and drives the gimbal motor to cause the gimbal to quickly move to the attitude before entering the compass calibration mode. Therefore, the flight controller can record and store the gimbal attitude before entering the compass calibration mode, in order to control the gimbal to return to the attitude before entering the compass calibration mode after exiting the compass calibration mode.

According to the gimbal control method of the embodiments, when it is determined that the movable object enters the compass calibration mode, the gimbal motor is controlled to enter a joint angle closed-loop operation mode. In the joint angle closed-loop operation mode, the gimbal is controlled to move from the current joint angle to a zero-angle position, and is locked to the zero-angle position. In this way, during the compass calibration, the gimbal remains relatively stationary relative to the movable object. As a result, the gimbal can be prevented from random movement during compass calibration that can cause the gimbal to hit the mechanical limit mechanism and damage the gimbal or motor. In addition, in the control method of the embodiments, after the compass calibration, the flight controller automatically controls the gimbal to enter the attitude closed-loop operation mode, so that the gimbal moves to the original attitude that the gimbal was at before the UAV enters the compass calibration mode. As a result, users do not need to readjust the gimbal, which improves the user experience.

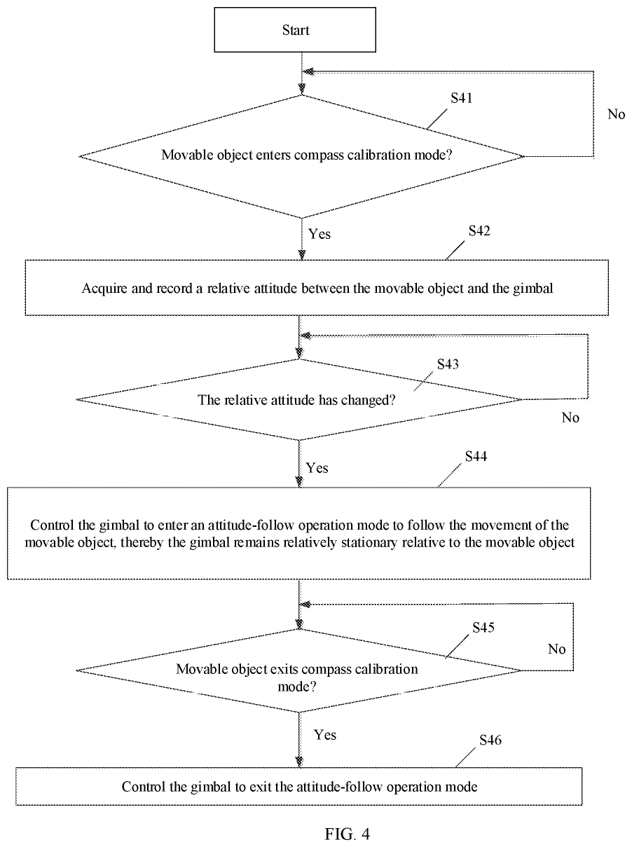

FIG. 4 is a flowchart of a gimbal control method according to another embodiment of the present disclosure. As shown in FIG. 4, at S41, it is determined whether a movable object enters a compass calibration mode.

For example, to determine whether the movable object enters the compass calibration mode, an instruction signal of entering the compass calibration mode can be sent to the UAV's flight controller via a remote control. After receiving the instruction signal, the UAV's flight controller can determine that the UAV enters the compass calibration mode, and then the control process proceeds to S42. Conversely, if the UAV's flight controller does not receive an instruction signal of entering the compass calibration mode, it can be determined that the UAV has not entered the compass calibration mode. The flight controller may continuously monitor whether the remote control sends an instruction signal of entering the compass calibration mode until the instruction signal is received.

If it is determined at S41 that the movable object enters the compass calibration mode, at S42, the flight controller acquires and records a relative attitude between the movable object and the gimbal. Specifically, the flight controller may obtain the original positions and/or attitudes of the movable object and the gimbal according to signals sent by measurement elements such as position sensors or attitude sensors provided at the movable object and the gimbal, and calculate an original relative attitude between the movable objects and the gimbal. The original relative attitude between the movable object and the gimbal can be stored in a memory.

At S43, the flight controller monitors whether the relative attitude between the movable object and the gimbal has changed. Specifically, the flight controller may obtain a new relative attitude between the movable object and the gimbal according to the real-time measurement signal sent from measurement elements such as position sensor or attitude sensors, and determine whether the relative attitude between the movable object and the gimbal has changed by comparing the new relative attitude with the original relative attitude stored in the memory. The flight controller continuously monitors the relative attitude between the movable object and the gimbal. When it is determined that the relative attitude between the movable object and the gimbal has changed, the process proceeds to S44.

At S44, the flight controller controls the gimbal to enter an attitude-follow operation mode. The attitude-follow operation mode refers to an automatic control process that uses the gimbal attitude as the control object and controls the gimbal attitude during the movement of the movable object to cause the gimbal to move following the movement of the movable object, thereby causing the gimbal to remain relatively stationary relative to the movable object. For example, during the compass calibration, when it is detected that the body of the UAV rotates forth with respect to the gimbal, the corresponding motor of the gimbal is controlled so that the gimbal also rotates forth for a same angle, thereby the gimbal remains relatively stationary relative to the movable object.

At S45, it is determined whether the movable object exits the compass calibration mode. For example, to determine whether the movable object exits the compass calibration mode, an instruction signal of exiting the compass calibration mode can be sent to the UAV's flight controller via the remote control. After receiving the instruction signal, the UAV's flight controller can determine that the UAV exits the compass calibration mode. The compass calibration mode can be exited after completing the compass calibration, or during the calibration. The flight controller may continuously monitor whether the remote control sends an instruction signal of exiting the compass calibration mode.

If the UAV's flight controller receives an instruction signal of exiting the compass calibration mode at S45, it can be determined that the UAV exits the compass calibration mode, and the control process proceeds to S46. At S46, the flight controller controls the gimbal to exit the attitude-follow operation mode. Then the flight controller can drive the gimbal motor based on needs to cause the gimbal to move to a target attitude, e.g., suitable for photographing.

According to the gimbal control method of the embodiments, when it is determined that the movable object enters the compass calibration mode, the gimbal motor is controlled to enter the attitude-follow operation mode, in which the gimbal is controlled to follow the movement of the movable object. In this way, during the compass calibration, the gimbal remains relatively stationary relative to the movable object. As a result, the gimbal can be prevented from random movement during compass calibration that can cause the gimbal to hit the mechanical limit mechanism and damage the gimbal or motor. In addition, in the control method of the embodiments, after the compass calibration, relative to the movable object, the gimbal still maintains the attitude as before entering the compass calibration mode, so that users do not need to readjust the gimbal, which improves the user experience.

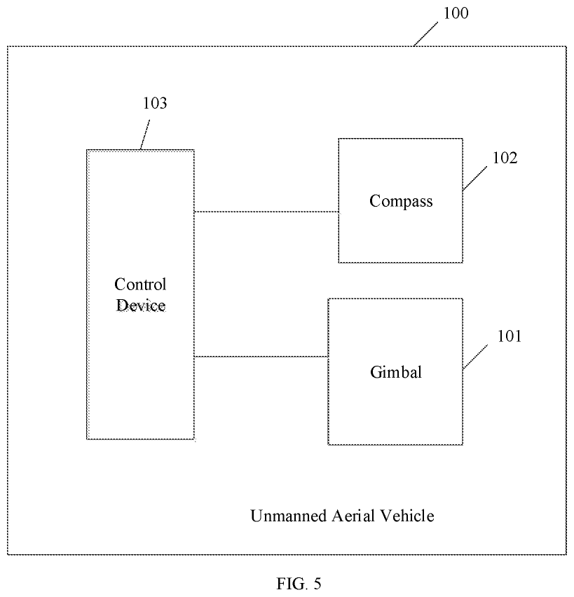

FIG. 5 is a system block diagram of the UAV 100 according to an embodiment of the present disclosure. Those skilled in the art should understand that the unmanned aerial vehicle in the embodiments of the present disclosure may be replaced by an unmanned ship, an unmanned vehicle, or any movable object equipped with a stabilizing gimbal and a compass, which is not limited in the present disclosure. As shown in FIG. 5, the UAV 100 includes a gimbal 101, a compass 102, and a control device 103. The control device 103 is provided at the body of the UAV 100. The gimbal 101 is used to carry a load. The load is, for example, a camera or a video camera for shooting photos and/or videos during the flight of the UAV. The gimbal 101 may be a three-axis stabilizing gimbal, and the three axes are perpendicular to each other, and are respectively used to adjust a pitch angle, a yaw angle, or a roll angle of the camera or video camera. The movement of each axis is controlled by the gimbal motor. The compass 102 is used to determine the azimuth during the flight of the UAV, and sends the position signal to the control device 103 to ensure that the UAV flies along a correct route. The control device 103 serves as a control center of the UAV for receiving signals from a remote-control device, a sensor, and etc., executing and processing various instructions and data, and controlling various movements of the UAV and/or the gimbal.

Since the compass is particularly susceptible to interference, it is often necessary to calibrate the compass during use. During the compass calibration, if user's operations are not standardized, such as turning too fast, the gimbal flutters and will easily hit the mechanical limit mechanism, which will cause the gimbal motor to output large torque for a long time and damage the gimbal or motor. On the other hand, activating the logic of avoiding the limit mechanism will make the attitude of the gimbal after the compass calibration inconsistent with the attitude before the compass calibration, therefore the user experience is not good.

In order to solve the above problems, according to the embodiments, the control device 103 may include one or more processors to perform determining whether the UAV 100 enters the compass calibration mode and controlling the movement of the gimbal 101 when it is determined that the UAV 100 enters the compass calibration mode, so that the gimbal 101 remains relatively stationary relative to the UAV 100.

Specifically, to determine whether the UAV 100 enters the compass calibration mode, an instruction signal of entering the compass calibration can be sent to the control device 103 through a remote control. After receiving the instruction signal, the control device 103 can determine that the UAV 100 has entered the compass calibration mode. Alternatively, a control button may be provided at the gimbal 101 or the UAV 100, and when the control button is pressed, the control device 103 is notified that the UAV 100 has entered the compass calibration mode. When the control device 103 determines that the UAV 100 enters the compass calibration mode, the movement of the gimbal 101 can be controlled by the gimbal motor, so that the gimbal 101 remains relatively stationary relative to the UAV 100. Alternatively, when the control device 103 determines that the UAV 100 enters the compass calibration mode, a mechanical locking mechanism may be activated so that the gimbal 101 remains relatively stationary relative to the UAV 100.

According to the embodiments, when it is determined that the UAV 100 enters the compass calibration mode and does not exit, the control device 103 controls the gimbal motor to enter a joint angle closed-loop operation mode. In the joint angle closed-loop operation mode, the control device 103 controls the gimbal 101 to move from the current joint angle to a zero-angle position. Specifically, a trapezoidal movement curve can be automatically planned according to the current joint angle of the gimbal, so that the gimbal can smoothly move to a zero-angle position.

During the compass calibration, this control process can be performed continuously and dynamically to lock the gimbal 101 to a zero-angle position. That is, whenever the joint angle deviates from the zero-angle position, the gimbal motor is controlled to return the gimbal 101 to the zero-angle position. For example, when the position sensor detects that the joint angle is negative, a forward torque is provided to the gimbal motor to make the motor rotate forth. Conversely, when a positive joint angle is detected, a backward torque is provided to the gimbal motor to make the motor rotate back.

According to the embodiments, when it is determined that the movable object such as UAV enters the compass calibration mode, the control device controls the gimbal motor to enter the joint angle closed-loop operation mode. In the joint angle closed-loop operation mode, the gimbal is controlled to move from the current joint angle to a zero-angle position, and is locked to the zero-angle position. In this way, during the compass calibration, the gimbal remains relatively stationary relative to the movable object. As a result, the gimbal can be prevented from random movement during compass calibration that can cause the gimbal to hit the mechanical limit mechanism and damage the gimbal or motor. In addition, the control method of the embodiments can be automatically executed by the control device with a written program, which improves the accuracy of the control and the convenience of the user.

Furthermore, according to the embodiments, during the compass calibration, the control device 103 may continuously monitor whether the remote control sends an instruction signal of exiting the compass calibration mode. If the control device 103 receives the instruction signal of exiting the compass calibration, it will control the gimbal motor to switch from the joint angle closed-loop operation mode to the attitude closed-loop operation mode. In the attitude closed-loop operation mode, according to the real-time measurement signal sent from measurement elements such as position sensors or attitude sensors, the flight controller performs attitude closed-loop control over the gimbal motor and drives the gimbal motor to cause the gimbal 101 to quickly move to the attitude before entering the compass calibration mode. Therefore, the control device 103 can record and store the attitude of gimbal 101 before entering the compass calibration mode, in order to control the gimbal 101 to return to the attitude as before entering the compass calibration mode after exiting the compass calibration mode.

According to the embodiments, after the compass calibration, the control device automatically controls the gimbal to enter the attitude closed-loop operation mode, so that the gimbal moves to the original attitude that the gimbal was at before entering the compass calibration mode. As a result, users do not need to readjust the gimbal, which improves the user experience.

According to some other embodiments, when it is determined that the UAV 100 enters the compass calibration mode, the control device 103 controls the gimbal motor to enter the attitude-follow operation mode. Specifically, the control device 103 may obtain the original positions and/or attitudes of the UAV 100 and the gimbal 101 according to signals sent by measurement elements such as position sensors or attitude sensors provided at the UAV 100 or the gimbal 101, and calculate an original relative attitude between the UAV 100 and the gimbal 101. The original relative attitude between the UAV 100 and the gimbal 101 can be stored in a memory.

Then the control device 103 can monitor whether the relative attitude between the UAV 100 and the gimbal 101 has changed. Specifically, the control device 103 may obtain a new relative attitude between the UAV 100 and the gimbal 101 according to the signal sent from measurement elements such as position sensor or attitude sensors, and determine whether the relative attitude between the UAV 100 and the gimbal 101 has changed by comparing the new relative attitude with the original relative attitude stored in the memory.

The control device 103 continuously monitors the relative attitude between the UAV 100 and the gimbal 101. When it is determined that the relative attitude between the UAV 100 and the gimbal 101 has changed, the control device 103 controls the gimbal 101 entering an attitude-follow operation mode to control the gimbal attitude. So that the gimbal 101 is controlled to follow the movement of the UAV 100, thereby the gimbal 101 remains relatively stationary relative to the UAV 100. For example, during the calibration of the compass 102, when it is detected that the body of the UAV 100 rotates forth with respect to the gimbal 101, the corresponding motor of the gimbal 101 is controlled so that the gimbal also rotates forth for a same angle accordingly, thereby the gimbal 101 remains relatively stationary relative to the UAV 100.

According to the embodiments, during the compass calibration, the control device 103 may continuously monitor whether the UAV 100 exits the compass calibration mode. For example, to determine whether the UAV 100 exits the compass calibration mode, an instruction signal of exiting the compass calibration mode can be sent to the control device 103 via a remote control. After receiving the instruction signal, the control device 103 can determine that the UAV 100 exits the compass calibration mode. The compass calibration mode can be exited after completing the compass calibration, or during the calibration.

If the control device 103 receives an instruction signal of exiting the compass calibration mode, the gimbal 101 is controlled to exit the attitude-follow operation mode. Then the control device 103 can drive the gimbal motor based on needs to cause the gimbal 101 to move to a target attitude, e.g., suitable for photographing.

According to the embodiments, when it is determined that the movable object such as a UAV enters the compass calibration mode, the gimbal motor is controlled to enter the attitude-follow operation mode, in which the gimbal is controlled to follow the movement of the movable object. In this way, during the compass calibration, the gimbal remains relatively stationary relative to the movable object. As a result, the gimbal can be prevented from random movement during compass calibration that can cause the gimbal to hit the mechanical limit mechanism and damage the gimbal or motor. In addition, in the control method of the embodiments, after the compass calibration, relative to the movable object, the gimbal still maintains the attitude as before entering the compass calibration mode, so that users do not need to readjust the gimbal, which improves the user experience.

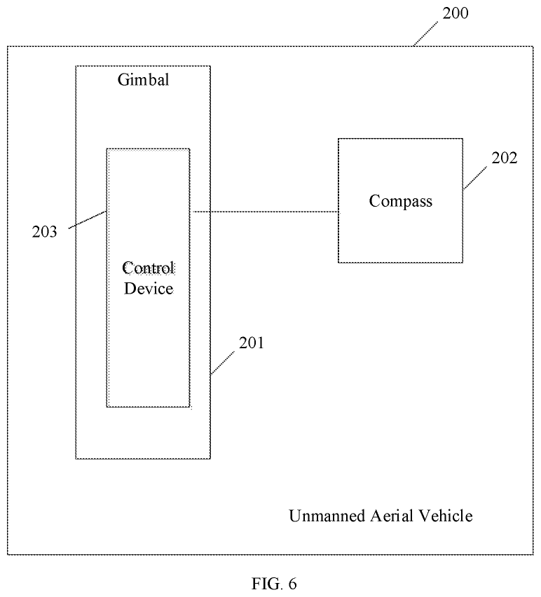

FIG. 6 is a system block diagram of a UAV 200 according to another embodiment of the present disclosure. As shown in FIG. 6, the UAV 200 includes a gimbal 201, a compass 202, and a control device 203. The control device 203 is provided at the gimbal 201. The gimbal 201 is used to carry a load. The load is, for example, a camera or a video camera for shooting photos and/or videos during the flight of the UAV. The gimbal 201 may be a three-axis stabilizing gimbal, and the three axes are perpendicular to each other, and are respectively used to adjust a pitch angle, a yaw angle, or a roll angle of the camera or video camera. The movement of each axis is controlled by the gimbal motor. The compass 202 is used to determine the azimuth during the flight of the UAV, and sends the position signal to the control device 203 to ensure that the UAV 200 flies along a correct route. The control device 203 serves as a control center of the UAV for receiving signals from a remote-control device, a sensor, and etc., executing and processing various instructions and data, and controlling various movements of the UAV and/or the gimbal.

The embodiment of FIG. 6 is different from the embodiment of FIG. 5 in that the control device 203 is disposed at the gimbal 201 instead of the body of the UAV 200. When the compass calibration is performed, the control device 203 of this embodiment can perform similar control to the control device 103 of the embodiment of FIG. 5, and the specific control process is not repeated here. This embodiment can also achieve the advantages and effects of the embodiment shown in FIG. 5.

According to other embodiments, the control device 103 or 203 may include a plurality of control modules or processors, and the plurality of control modules or processors are disposed together at the body of the gimbal or UAV, or are respectively disposed at the gimbal and UAV.

The embodiments in FIG. 5 and FIG. 6 both describe the control related to the compass calibration, but the control device 103 or 203 can be used to control other operations of the UAV or the gimbal at the same time. Alternatively, the control device 103 or 203 may be a separate processor, which is specifically used to perform control related to the compass calibration.

Other embodiments of the present disclosure provide a storage device for storing program instructions that can be executed by a control device of a movable object such as a UAV as shown in FIGS. 5 and 6 to execute the control methods shown in FIGS. 1-4. The storage device includes various media that can store programs, such as a U disk, a portable hard disk, a read-only memory (ROM), a random-access memory (RAM), a magnetic disk, or an optical disk. The storage device may exist alone or may be included in other devices. For example, the storage device may be integrated in the gimbal or a remote control device.

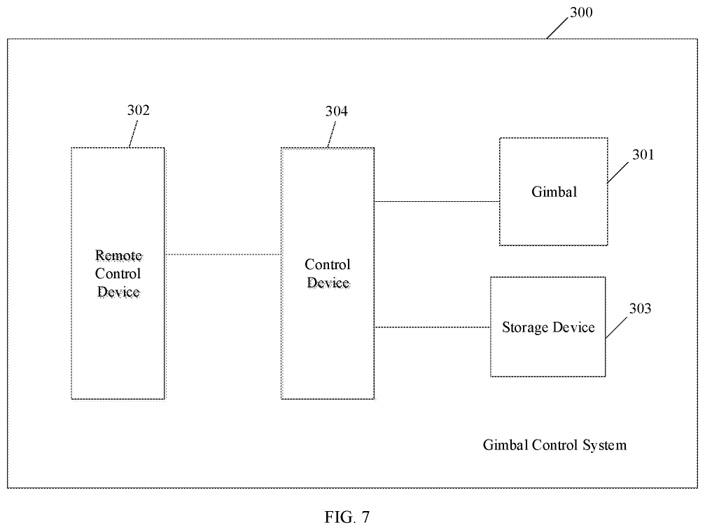

FIG. 7 is a block diagram of a gimbal control system according to an embodiment of the present disclosure. As shown in FIG. 7, a gimbal control system 300 includes a gimbal 301, a remote control device 302, a storage device 303, and a control device 304. The gimbal 301 is disposed at a movable object such as a UAV, and a load such as a camera or a video camera can be mounted thereon. The remote control device 302 is configured to send an instruction signal to the gimbal 301. The storage device 303 is configured to store program instructions. The control device 304 receives the instruction signal sent by the remote control device 302 and executes the program instructions stored in the storage device 303.

The remote control device 302 may be a mobile device, such as a smartphone, a tablet, a laptop, a personal digital assistant, a wearable device (such as glasses, a wristband, an armband, gloves, a helmet, a pendant), or any other type of mobile device. The remote control device 302 may or may not include a display device. The storage device 303 includes various media and devices that can store program instructions, such as a U disk, a portable hard disk, a read-only memory (ROM), a random-access memory (RAM), a magnetic disk, or an optical disk. Optionally, the storage device 303 may be integrated in the gimbal 301 or the remote control device 302. Alternatively, the control device 304 may be integrated in the gimbal 301. The remote control device 302 and the control device 304 can perform wired or wireless communication to transmit control instructions, data, images, and the like to each other.

In the embodiments, when the compass calibration is required, the remote control device 302 sends an instruction signal of the UAV entering the compass calibration mode to the gimbal. The storage device 303 stores program instructions, which are configured to perform the methods described in the embodiments of FIGS. 1-4. After receiving the instruction signal sent by the remote control device 302, the control device 304 executes the program instructions stored on the storage device 303 to execute the method described in the embodiment of FIGS. 1-4.

Another embodiment of the present disclosure provides a gimbal, which is disposed at a movable object such as a UAV, and can carry a load such as a camera, a video camera, and the like. The gimbal includes a control device. When a compass calibration is required, the control device performs the method described in the embodiment of FIGS. 1-4.

According to the gimbal control method, the movable object, the storage device, the gimbal control system, and the gimbal described in the embodiments of the present disclosure, when a compass calibration is required, the gimbal movement is controlled, so that the gimbal remains relatively stationary relative to the movable object. As a result, the gimbal can be prevented from random movement during compass calibration that can cause the gimbal to hit the mechanical limit mechanism and damage the gimbal or motor. In addition, after the compass calibration, the gimbal can be controlled to return to the original attitude relative to the movable object that the gimbal was at before entering the compass calibration mode, so that users do not need to readjust the gimbal, which improves the user experience.

The above embodiments of the present disclosure are described with examples, but those skilled in the art will recognize that various modifications and changes can be made to the embodiments of the present disclosure without deviating from the concept of the present disclosure. The embodiments may be combined with each other and partially replaced, as long as no conflicts exist. All such modifications and changes should fall within the scope of this disclosure. Therefore, the scope of the invention shall be subject to the scope defined by the claims.

What is claimed is:

1. A gimbal control method comprising:
determining whether a movable object enters a compass calibration mode; and
in response to the movable object entering the compass calibration mode, controlling a gimbal movement of a gimbal carried by the movable object so that the gimbal remains relatively stationary relative to the movable object.

2. The gimbal control method of claim 1, wherein controlling the gimbal movement includes controlling a gimbal motor to enter a joint angle closed-loop operation mode, in which the gimbal is controlled to move to a zero-angle position at which a joint angle of the gimbal is zero.

3. The gimbal control method of claim 2, further comprising:
locking the gimbal to the zero-angle position during compass calibration.

4. The gimbal control method of claim 3, further comprising, in response to the movable object exiting the compass calibration mode:
controlling the gimbal to enter an attitude closed-loop operation mode to cause the gimbal to return to an attitude before the movable object enters the compass calibration mode.

5. The gimbal control method of claim 1, wherein controlling the gimbal movement comprising:
controlling the gimbal motor so that the gimbal moves with a movement of the movable object.

6. The gimbal control method of claim 1, wherein controlling the gimbal movement includes activating a mechanical locking mechanism to lock the gimbal to a relative position relative to the movable object.

7. A gimbal configured to be disposed at a movable object and comprising a control device configured to perform the method according to claim 1.

8. A movable object comprising:
a gimbal;
a compass; and
a control device configured to:
determine whether the movable object enters a compass calibration mode for calibrating the compass; and
in response to the movable object entering the compass calibration mode, control a gimbal movement of the gimbal so that the gimbal remains relatively stationary relative to the movable object.

9. The movable object of claim 8, wherein the movable object includes an unmanned aerial vehicle.

10. The movable object of claim 8, wherein the gimbal is configured to carry a photographing device.

11. The movable object of claim 8, wherein the control device is disposed at a body of the movable object.

12. The movable object of claim 8, wherein the control device is disposed at the gimbal.

13. The movable object of claim 8, wherein the control device is configured to receive an instruction signal from a remote control device to determine whether the movable object enters the compass calibration mode.

14. A gimbal control system comprising:
a gimbal configured to be disposed at a movable object;
a remote control device configured to send an instruction signal for controlling the gimbal;
a storage device storing program instructions; and
a control device configured to receive the instruction signal sent by the remote control device and execute the program instructions stored at the storage device to:
determine whether the movable object enters a compass calibration mode; and
in response to the movable object entering the compass calibration mode, control a gimbal movement of the gimbal so that the gimbal remains relatively stationary relative to the movable object.

15. The gimbal control system of claim 14, wherein the storage device is integrated with the gimbal or the remote control device.

16. The gimbal control system of claim 14, wherein the control device is integrated with the gimbal.
